(19) United States
(12) Patent Application Publication
(10) Pub. No.: US 2023/0221514 A1
(43) Pub. Date: Jul. 13, 2023

(54) OPTICAL FIBER CABLE WITH DIFFERENT BINDER PITCH

(71) Applicant: Sterlite Technologies Limited, Hiryana (IN)

(72) Inventor: Kishore Sahoo, Haryana (IN)

(21) Appl. No.: 18/147,203

(22) Filed: Dec. 28, 2022

(30) Foreign Application Priority Data
Jan. 12, 2022 (IN) 202211001824

(51) Int. Cl. G02B 6/44

(52) U.S. Cl. CPC G02B 6/4413; G02B 6/4434; G02B 6/443

(57) ABSTRACT

The present invention relates to an optical fiber cable (200) with a different binder pitch comprising a plurality of tubes (204) with one or more optical transmission elements (202), a first binder (208) and a second binder (210) wound around the plurality of tubes (204) helically. The first lay length of the first binder (208) is different than a second lay length of the second binder (210) and a lay ratio of the first lay length to the second lay length is equal to or more than 1.2. And the difference between a first stranding angle and a second stranding angle of the first binder (208) and the second binder (210) respectively is greater than or equal to 5 degrees.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### CROSS REFERENCE TO RELATED APPLICATION

This application claims the benefit of Indian Patent Application No. 202211001824, entitled “OPTICAL FIBER CABLE WITH DIFFERENT BINDER PITCH” filed by the applicant on Jan. 12, 2022, which is incorporated herein by reference in its entirety.

### FIELD OF THE INVENTION

Embodiments of the present invention relate to the field of optical fiber cables and more particularly relates to an optical fiber cable with a different binder pitch.

### BACKGROUND OF THE INVENTION

Optical fiber cables have secured an important position in building the optical network of modern communication systems across the globe. The optical fiber cables are part of millions of miles of the optical network that provide better connectivity and high bandwidth.

An optical fiber (i.e., a glass fiber typically surrounded by one or more coating layers) conventionally includes an optical fiber core, which transmits and/or amplifies an optical signal, and an optical cladding, which confines the optical signal within the core. Accordingly, the refractive index of the core nc is typically greater than the refractive index of the optical cladding ng (i.e., nc>ng).

Optical fiber cables generally include a plurality of strength members for improving the tensile strength of optical fibers and a plurality of water blocking members for preventing the intrusion of moisture into the optical fibers. Such optical fiber cables may have a loose tube structure with optical fibers contained in a plurality of tubes or a ribbon cable structure with a plurality of ribbon optical fibers. At present, in the optical fiber communication network, the loose tube layer stranded type and the central tube type optical cable are widely used. In the optical cable of these structures, the optical fiber loose tube is the core component of its composition.

In the manufacturing process of traditional stranded optical cables, loose tubes need to be twisted together in S-type and SZ-type to strengthen the tensile performance of the optical cable, reduce the strength components, and save the cost of optical cable manufacturing. Moreover, binding of the loose tubes is necessary to hold the optical components properly.

European patent application no. EP2390700 titled “Bundled fiber optic cables” discloses binding technique in which two binders 104, 106 are contra-helically wound with the same pitch to restrict opening of stranded loose tubes 102.

FIG. 1 is a pictorial snapshot illustrating a binding technique in which two binders 104, 106 are contra-helically wound with the same pitch to restrict opening of stranded loose tubes 102, in accordance with an embodiment of the prior art.

US patent application no. U.S. Pat. No. 8,184,934B2 titled “Optical fiber cable” discloses an fiber optic cable having a jacket, at least one tube and at least two fibers within the tube in a loose tube arrangement.

US patent application no. US20050265674A1 titled “Optical fiber cable” discloses an optical fiber cable including a plurality of loose tubes and an outer jacket for binding the loose tubes.

However, there are a few drawbacks in the current technologies employing optical fiber cables with loose tubes. In particular, due to the same pitch of the binders, all overlapping portions of the binders align longitudinally along the length of the optical fiber cables, which drives a risk of the loose tubes bulging out from the positions where there is no overlap between the binders. Moreover, as the structure of the optical cable decreases, the size of the loose tube is also continuously reduced, and the wall thickness is getting thinner and thinner. As the dry optical cable disclosed in the prior arts uses water blocking yarn instead of grease, the inner side of the loose tube lacks support. During the production process, the fluctuation of the yarn binding tension will affect the quality of the loose tube. Alternatively, when the yarn binding tension is too small, the loose tube will spread out and the outer diameter will change.

Accordingly, to overcome the disadvantages of the prior arts, there is a need for a technical solution that overcomes the above-stated limitations in the prior arts. The present invention provides an optical fiber cable with improved binding technique.

### SUMMARY OF THE INVENTION

Embodiments of the present invention discloses at least two binders having different binder pitch (synonymously referred to as “lay-length”). The optical fiber cable comprises a plurality of tubes such that each of the plurality of tubes encloses one or more optical transmission elements, a first binder and a second binder wound around the plurality of tubes. In particular, the first lay length of the first binder is different from the second lay length of the second binder.

In accordance with an embodiment of the present invention, the lay ratio is equal to or more than 1.2. And, the lay ratio is a ratio of the first lay length of the first binder to the second lay length of the second binder. Alternatively, the lay ratio is a ratio of the second lay length of the second binder to the first lay length of the first binder.

In accordance with an embodiment of the present invention, the plurality of tubes is arranged in one or more layers. Particularly, each layer is wound by a pair of binders. Moreover, the plurality of tubes is stranded around a central strength member. Further, the plurality of tubes is stranded in SZ fashion.

In accordance with an embodiment of the present invention, the first binder and the second binder are wound around the plurality of tubes helically. The first binder is wound in a clockwise direction and the second binder is wound in an anti-clockwise direction. Alternatively, the first binder and the second binder are wound in the same direction.

In accordance with an embodiment of the present invention, a difference between a first stranding angle and a second stranding angle of the first binder and the second binder respectively is greater than or equal to 5 degrees.

In accordance with an embodiment of the present invention, the first binder and the second binder are single-end type binders. Alternatively, the first binder and the second binder are dual-end type binders.

The foregoing objectives of the present invention are attained by employing an optical cable with a different binder pitch. These and other aspects herein will be better appreciated and understood when considered in conjunction with the following description and the accompanying drawings. It should be understood, however, that the following descriptions are given by way of illustration and not of limitation. Many changes and modifications may be made within the scope of the invention herein without departing from the spirit thereof.

### BRIEF DESCRIPTION OF THE DRAWINGS

So that the manner in which the above recited features of the present invention is understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

The invention herein will be better understood from the following description with reference to the drawings, in which:

FIG. 1 is a snapshot illustrating a conventional binding technique depicting a same binder pitch in accordance with a prior art;

FIG. 2 is a snapshot illustrating an optical fiber cable with different binder pitch in accordance with an embodiment of the present invention;

FIG. 3 is a snapshot illustrating a binding technique depicting the different binder pitch in accordance with another aspect of the present invention.

### ELEMENT LIST

Optical fiber cable—200
Optical transmission elements—202
Plurality of tubes—204
Central strength member—206
Transmission elements—208
Second binder—210
Binder layer—212
Outer layer—214

The optical fiber as illustrated in the accompanying drawings, which like reference letters indicate corresponding parts in the various figures. It should be noted that the accompanying figure is intended to present illustrations of exemplary embodiments of the present invention. This figure is not intended to limit the scope of the present invention. It should also be noted that the accompanying figure is not necessarily drawn to scale.

### DETAILED DESCRIPTION OF THE PREFERRED EMBODIMENTS

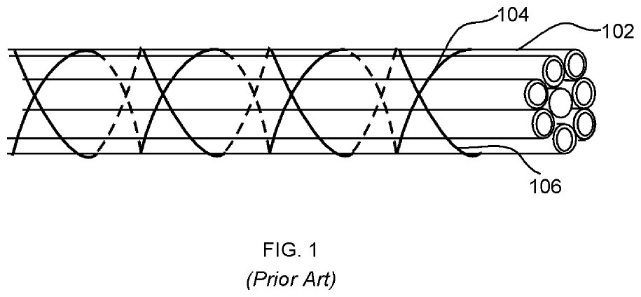

The principles of the present invention and their advantages are best understood by referring to FIG. 1 to FIG. 3. In the following detailed description numerous specific details are set forth in order to provide a thorough understanding of the embodiment of invention as illustrative or exemplary embodiments of the invention, specific embodiments in which the invention may be practiced are described in sufficient detail to enable those skilled in the art to practice the disclosed embodiments. However, it will be obvious to a person skilled in the art that the embodiments of the invention may be practiced with or without these specific details. In other instances, well known methods, procedures and components have not been described in detail so as not to unnecessarily obscure aspects of the embodiments of the invention.

The following detailed description is, therefore, not to be taken in a limiting sense, and the scope of the present invention is defined by the appended claims and equivalents thereof. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. References within the specification to “one embodiment,” “an embodiment,” “embodiments,” or “one or more embodiments” are intended to indicate that a particular feature, structure, or characteristic described in connection with the embodiment is included in at least one embodiment of the present invention.

Although the terms first, second, etc. may be used herein to describe various elements, these elements should not be limited by these terms. These terms are generally only used to distinguish one element from another and do not denote any order, ranking, quantity, or importance, but rather are used to distinguish one element from another. Further, the terms “a” and “an” herein do not denote a limitation of quantity, but rather denote the presence of at least one of the referenced items.

Conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

The Following Brief Definition of Terms Shall Apply Throughout the Present Invention:

An optical fiber refers to a medium associated with transmission of information over long distances in the form of light pulses. The optical fiber uses light to transmit voice and data communications over long distances when encapsulated in a jacket/sheath. The optical fiber may be of ITU.T G.657.A2 category. Alternatively, the optical fiber may be of ITU.T G.657.A1 or G.657.B3 or G.652.D or other suitable category.

ITU.T, stands for International Telecommunication Union-Telecommunication Standardization Sector, is one of the three sectors of the ITU. The ITU is the United Nations specialized agency in the field of telecommunications and is responsible for studying technical, operating and tariff questions and issuing recommendations on them with a view to standardizing telecommunications on a worldwide basis.

Crush resistance is an ability of a cable to withstand and/or recover from the effects of a compressive force.

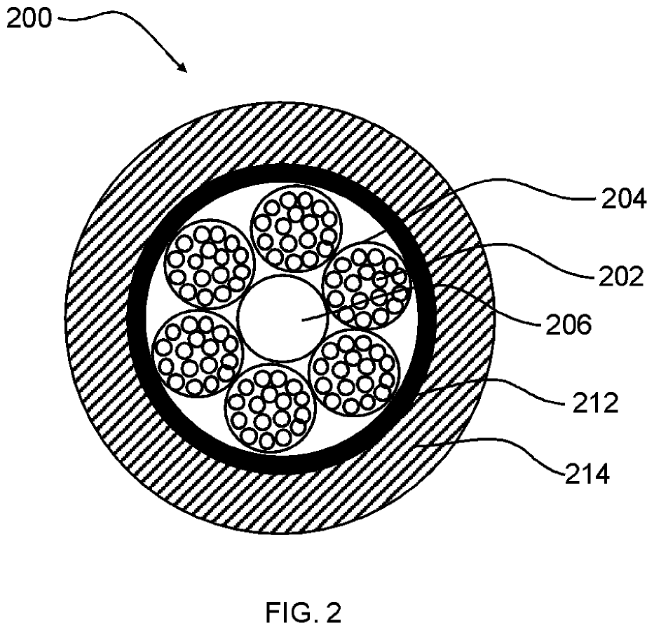

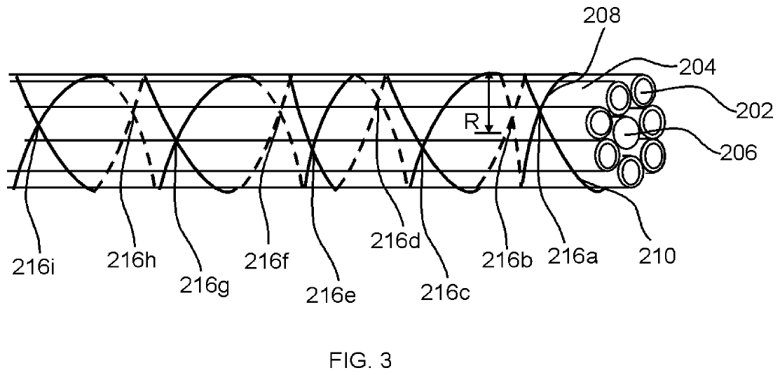

Now we will simultaneously refer to FIG. 2, a snapshot illustrating an optical fiber cable with different binder pitch in accordance with an embodiment of the present invention and FIG. 3, a snapshot illustrating a binding technique depicting the different binder pitch in accordance with another aspect of the present invention. The optical fiber cable 200 includes one or more optical transmission elements 202, a plurality of tubes 204, a central strength member 206, a binder layer 212 and an outer layer 214. In particular, the one or more optical transmission elements (aka “optical fiber”) 202 may be present in form of, but not limited to, a group of loose optical fibers, a group of optical fiber ribbons or a stack of optical fiber ribbons, a group of rollable ribbons, a group of corrugated ribbons, a group of partially/intermittently bonded optical fiber ribbons, a group of flat ribbons.

In accordance with an embodiment of the present invention, the optical fiber may be a bend insensitive fiber that has less degradation in optical properties or less increment in optical attenuation during bending of the optical fiber cable and to maintain the optical properties during multiple winding/unwinding operations of the optical fiber cable.

In some aspects of the invention, the optical fiber may be coloured fiber. The optical fiber may be a single-core optical fiber, a multi-core optical fiber, a single-mode optical fiber, a multimode optical fiber or the like. The single mode optical fiber carries only a single mode of light and the multimode optical fiber carries multiple modes of light to propagate. The multicore optical fibers consist of multiple cores as opposed to the single-core optical fiber that comprise only a single core.

The one or more optical transmission elements 202 may be encapsulated in the plurality of tubes 204. In particular, the plurality of tubes 204 provide mechanical isolation and protection to the one or more optical transmission elements 202 from physical damages. Moreover, the plurality of tubes 204 may be but not limited to buffer tubes, loose tubes, tight buffered tubes, flexible tubes. Further, the plurality of tubes 204 may be made up of, but not limited to, PBT (polybutylene terephthalate), polypropylene (PP), polyamide, thermoplastic material or a combination of any suitable material.

In an alternate embodiment of the present invention, the plurality of tubes 204 may be stranded around each other.

The plurality of tubes 204 may be stranded around the central strength member 206 in SZ fashion. In SZ stranding, a number of turns are wound in S direction and then a number of turns in Z direction throughout the length. In particular, the central strength member 206 may provide mechanical strength, stiffness to the optical fiber cable 200, enhanced break load and excellent crush protection/resistance performance. Further, the central strength member 206 may be made of, but not limited to, FRP (Fiber Reinforced Plastic), ARP (Aramid Reinforced Plastic) or any other suitable dielectric/strength material. The central strength member 206 may have a round shape, a flat shape or any other suitable shape.

In accordance with an embodiment of the present invention, the plurality of tubes 204 may be encapsulated by the binder layer 212. In particular, the binder layer 212 may be formed by a pair of binders, i.e., a first binder 208 and a second binder 210 (as shown in FIG. 3). Moreover, the first binder 208 and the second binder 210 may be wound around the plurality of tubes 204 helically such that a first lay length of the first binder 208 is different than a second lay length of the second binder 210. The lay ratio is a ratio of the first lay length (L1) to the second lay length (L2) or a ratio of the second lay length to the first lay length. Further, lay ratio is equal to or more than 1.2

In an exemplary example, if the first binder 208 has the first lay length (L1) as 50 mm and the second binder 210 has the second lay length (L2) as 35 mm, then the lay ratio will be 1.4.

In an implementation, the first binder 208 may be wound in a clockwise direction and the second binder 210 may be wound in an anti-clockwise direction. In an alternative implementation, the first binder 208 may be wound in an anti-clockwise direction and the second binder 210 may be wound in a clockwise direction. In yet alternative implementation, the first binder 208 and the second binder 210 may be wound in the same direction. In yet another alternative implementation, for a tubeless optical fiber cable, the first binder 208 and the second binder 210 may be wound around one or more bundles of optical transmission elements 202. The first binder 208 and the second binder 210 may be coloured and/or coated with a water swellable material and/or a fire retardant material.

The first binder 208 and the second binder 210 may be defined by a first stranding angle and a second stranding angle. The difference between the first stranding angle and the second stranding angle is greater than or equal to ±5 degrees. A stranding angle (a) may be given as

α=tan⁻¹(;

wherein L is a lay length and R is a stranding radius.

For example, L1=50 mm, L2=35 mm, R=4 mm, then α₁=tan⁻¹(50/2* and α₂=tan⁻¹(35/2*. Accordingly, α₁−α₂=9 degrees.

Generally, the stranding angle is an angle between a stranding element i.e., binders and cross-section of the optical fiber cable 200, the stranding radius R is a distance between a longitudinal cable axis and middle of the stranding element and the lay length refers to a distance required to complete one revolution of the stranding element around a diameter of a bundle of the plurality of tubes 204.

The first binder 208 and the second binder 210 may be single-end type binders. Alternatively, the first binder 208 and the second binder 210 may be dual-end type binders. Alternatively, the first binder 208 and the second binder 210 may be a combination of a single-end type binder and a dual-end type binder. Typically, in a single-end type binder, all filaments of a binder are assembled together in a single group, whereas, in a dual-end type binder, the filaments of the binder are assembled in two groups, having substantially equal number of filaments in each group.

In accordance with an embodiment of the present invention, the plurality of tubes 204 may be arranged in one or more layers. In particular, each layer is wound by the pair of binders having aforesaid parameters and characteristics. The binder layer 212 may be surrounded by the outer layer 214. The outer layer 214 may be a jacket or a sheath.

Usually, sheathing (extrusion) is a process of squeezing a molten sheathing material through a funnel of a die as the core runs through the center performed at a high temperature (preferably more than 100° C.). The sheathing material for the sheath may include, but not limited to, polyvinyl chloride, polyethylene (such as High Density Poly Ethylene (HDPE), Medium Density Poly Ethylene, and Low Density Poly Ethylene), polyurethane, thermoplastic rubber/elastomer, thermoplastic chlorinated polyethylene or combination thereof.

Advantageously, the optical fiber cable with at least two binders having different binder pitch due to different binder pitch or lay lengths, radial position of overlapping portions (216a, 216b, 216c, 216d, 216e, 216f, 216g, 216h, 216i), of the pair of binders along the length provides a better hold on the stranded plurality of tubes 204 and avoids bulging issues, thereby facilitating easy handling. Further, one lay-length can be kept bigger in the optical fiber cable 200, i.e., lesser amount of binder is required, which reduces the cost.

It may be noted that the optical fiber cable 200 may contain one or more elements depending upon requirement and implementation. Non-limiting examples of the one or more elements are binders, water blocking tape, fire retardant tape, metal tape, rip cords, water swellable yarns, water blocking gel, strength yarns, dielectric armoring, ECCS (Electro Chrome Coated Steel) tape etc.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

It will be apparent to those skilled in the art that other embodiments of the invention will be apparent to those skilled in the art from consideration of the specification and practice of the invention. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope of the invention. It is intended that the specification and examples be considered as exemplary, with the true scope of the invention being indicated by the claims.

We claim:

1. An optical fiber cable (200), comprising:
a plurality of tubes (204) such that each of the plurality of tubes (204) encloses one or more optical transmission elements (202); and
a first binder (208) and a second binder (210) wound around the plurality of tubes (204),
wherein a first lay length of the first binder (208) is different than a second lay length of the second binder (210).

2. The optical fiber cable (200) as claimed in claim 1, wherein a lay ratio is equal to or more than 1.2.

3. The optical fiber cable (200) as claimed in claim 1, wherein the lay ratio is a ratio of the first lay length of the first binder (208) to the second lay length of the second binder (210).

4. The optical fiber cable (200) as claimed in claim 1, wherein the lay ratio is a ratio of the second lay length of the second binder (210) to the first lay length of the first binder (208).

5. The optical fiber cable (200) as claimed in claim 1, wherein the plurality of tubes (204) is arranged in one or more layers.

6. The optical fiber cable (200) as claimed in claim 1, wherein each layer is wound by a pair of binders.

7. The optical fiber cable (200) as claimed in claim 1, wherein the plurality of tubes (204) is stranded around a central strength member (206).

8. The optical fiber cable (200) as claimed in claim 1, wherein the plurality of tubes (204) is stranded in SZ fashion.

9. The optical fiber cable (200) as claimed in claim 1, wherein the first binder (208) and the second binder (210) are wound around the plurality of tubes (204) helically.

10. The optical fiber cable (200) as claimed in claim 1, wherein the first binder (208) is wound in a clockwise direction and the second binder (210) is wound in an anti-clockwise direction.

11. The optical fiber cable (200) as claimed in claim 1, wherein the first binder (208) and the second binder (210) are wound around the plurality of tubes (204) helically.

12. The optical fiber cable (200) as claimed in claim 1, wherein the first binder (208) and the second binder (210) are wound in a same direction.

13. The optical fiber cable (200) as claimed in claim 1, wherein a difference between a first stranding angle and a second stranding angle of the first binder (208) and the second binder (210) respectively is greater than or equal to 5 degrees.

14. The optical fiber cable (200) as claimed in claim 1, wherein the first binder (208) and the second binder (210) are single-end type binders.

15. The optical fiber cable (200) as claimed in claim 1, wherein the first binder (208) and the second binder (210) are dual-end type binders.

16. The optical fiber cable (200) as claimed in claim 1, wherein the binder layer (212) is surrounded by the outer layer (214).

17. The optical fiber cable (200) as claimed in claim 1, wherein the outer layer (214) is a jacket or a sheath.

18. The optical fiber cable (200) as claimed in claim 1, wherein the sheath is made up of polyvinyl chloride, polyethylene (such as High Density Poly Ethylene (HDPE), Medium Density Poly Ethylene, and Low Density Poly Ethylene), polyurethane, thermoplastic rubber/elastomer, thermoplastic chlorinated polyethylene or combination thereof.

19. The optical fiber cable (200) as claimed in claim 1, wherein the first binder (208) and the second binder (210) is coated with a water swellable material and/or a fire retardant material.

20. The optical fiber cable (200) as claimed in claim 1, wherein the plurality of tubes (204) are stranded around each other.
